(19) United States
(12) Patent Application Publication
(10) Pub. No.: US 2018/0340454 A1
(43) Pub. Date: Nov. 29, 2018

(54) Open Thermodynamic Cycle Utilizing Supercritical Carbon Dioxide Without Compressors

(71) Applicant: New FG Co, LLC, Pasadena, CA (US)

(72) Inventor: Stan Andy Smogorzewski, San Diego, CA (US)

(73) Assignee: New FG Co, LLC, Pasadena, CA (US)

(21) Appl. No.: 15/775,759

(22) PCT Filed: Nov. 11, 2016
(86) PCT No.: PCT/US16/61582

§ 371 Date: May 11, 2018

Related U.S. Application Data
(60) Provisional application No. 62/255,371, filed on Nov. 13, 2015.

(51) Int. Cl. F01K 25/10; F02C 3/36; F02C 7/08; F02C 3/34; F01D 15/08; F01D 15/10

(52) U.S. Cl. CPC F01K 25/103; F02C 3/36; F02C 7/08; F05D 2220/32; F01D 15/08; F01D 15/10; F05D 2220/76; F02C 3/34

(57) ABSTRACT

The present invention is directed to methods and systems for utilizing supercritical carbon dioxide in an open thermodynamic cycle in which no compressors are used. In some embodiments, a method for utilizing supercritical carbon dioxide includes combusting oxygen, fuel, and heated recycled supercritical carbon dioxide to produce a gas that is fed to a turbine to generate power; using the exhaust gas from the turbine to preheat the recycled supercritical carbon dioxide that is fed to the turbine; and pass the exhaust gas through a series of two sets of condensers and separators to provide a carbon dioxide stream from which the recycled supercritical carbon dioxide is generated using a pump. Power for the pump is provided by the turbine, which also provides power to an electric generator.

### BACKGROUND OF THE INVENTION

### Field of the Invention

The invention and its various embodiments relate to methods and systems for utilizing supercritical carbon dioxide (sCO₂) as a working fluid in an open thermodynamic cycle that produces mechanical power, electrical power, or both and a commercial grade sCO₂ product. In particular, the invention and its various embodiments relate to the use of an open thermodynamic cycle using sCO₂ as a working fluid without the need for compressors, which provides the advantages of simplicity and thermal efficiency.

### Description of Related Art

Fossil fuel combustion for power generation typically use thermodynamic cycles that rely upon water as a working fluid. Therefore, a thermodynamic cycle that utilizes sCO₂ as a working fluid, without compressors, and that provides power with improved simplicity and thermal efficiency is desirable.

### BRIEF DESCRIPTION OF THE INVENTION

In general, the present invention is directed towards an open thermodynamic cycle utilizing supercritical carbon dioxide (sCO₂) as a working fluid that operates without compressors to produce mechanical power, electrical power, or both and a commercial grade sCO₂ product. In some embodiments, a method for utilizing sCO₂ includes combusting oxygen, fuel, and preheated recycled sCO₂ to produce a gas that is fed to a turbine to generate power; using the exhaust gas from the turbine to preheat the recycled supercritical carbon dioxide that is fed to the turbine; and passing the exhaust gas through a series of two sets of condensers and separators to provide a carbon dioxide stream from which the recycled supercritical carbon dioxide is generated using a pump that is powered by the turbine.

In some embodiments, the exhaust gas from the turbine provides a carbon dioxide stream, from which the recycled supercritical carbon dioxide is generated, that includes other exhaust gases from the turbine. These other exhaust gases are separated from the carbon dioxide and expanded in an expander that also provide power to the pump used to generate the sCO₂. In some embodiments, a single shaft is used that is common to the turbine, expander, and the pump used to generate the sCO₂. In addition, excess sCO₂ may be removed from the system as a commercial grade sCO₂ product.

### BRIEF DESCRIPTION OF THE DRAWINGS

FIG. 1 is a process flow diagram of a process according to one embodiment of the invention.

### DETAILED DESCRIPTION OF THE INVENTION

The present invention is more fully described below with reference to the accompanying drawings. While the invention will be described in conjunction with particular embodiments, it should be understood that the invention can be applied to a wide variety of applications, and it is intended to cover alternatives, modifications, and equivalents as may be included within the spirit and scope of the invention. Accordingly, the following description is exemplary in that several embodiments are described (e.g., by use of the terms “preferably” or “for example”), but this description should not be viewed as limiting or as setting forth the only embodiments of the invention, as the invention encompasses other embodiments not specifically recited in this description. Further, the use of the term “invention” throughout this description is used broadly and is not intended to mean that any particular portion of the description is the only manner in which the invention may be made or used.

In general, the present invention is directed towards methods and systems for utilizing supercritical carbon dioxide (sCO₂) in an open thermodynamic cycle without compressors. In some embodiments, the methods and systems for utilizing sCO₂ as a working fluid include combusting oxygen, fuel, and preheated recycled sCO₂ to produce a gas that is fed to a turbine to generate power; using the exhaust gas from the turbine to preheat the recycled supercritical carbon dioxide that is fed to the turbine; and passing the exhaust gas through a series of condensers and separators to provide a carbon dioxide stream from which the recycled supercritical carbon dioxide is generated using a pump that is powered by the turbine.

The thermodynamic cycle may produce mechanical power, electrical power, or both, and may produce commercial grade sCO₂ at a specific pressure and purity. In certain embodiments of the invention, the open thermodynamic cycle does not utilize compressors. Such a cycle therefore has inherent advantages of simplicity and thermal efficiency as compared to other configurations.

In some embodiments, the exhaust gas from the turbine includes not only the carbon dioxide stream from which the recycled supercritical carbon dioxide is generated, but other exhaust gases from the turbine. These other exhaust gases are separated from the carbon dioxide downstream of the condensers and separators and expanded in an expander that also provides power to the pump used to generate the sCO₂. In some embodiments, a single shaft is used that is common to the turbine, expander, and the pump used to generate the sCO₂. In addition, excess sCO₂ may be removed from the system as a commercial grade sCO₂ product.

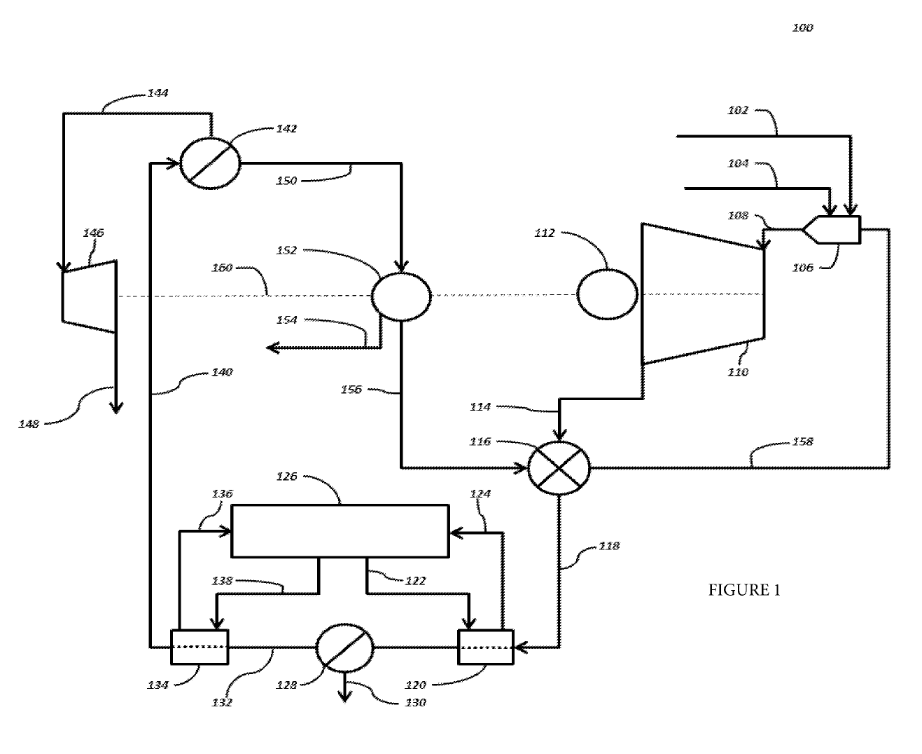

FIG. 1 is a process flow diagram of a process according to one embodiment of the invention. Specifically, FIG. 1 shows an open thermodynamic cycle 100 that utilizes sCO₂ as a working fluid but without the need for compressors.

In the thermodynamic cycle 100, oxygen 102 and fuel 104 at high pressure are combined in a combustion reaction in a combustor 106. The oxygen 102 may originate from any kind of process that provides enriched or pure oxygen. In some embodiments, the enriched oxygen is at a purity of higher than 95% by volume. The fuel 104 may be gaseous, liquid, or a mixture of gaseous and liquid fuels, but should not contain solids. In addition to the oxygen 102 and fuel 104, heated recycled sCO₂ 158 is also added to the combustor 106 to limit the combustion temperature of the thermodynamic cycle 100.

The resulting or combusted gas 108 from the combustion or combustor exhaust gas exits the combustor 106 and enters a turbine 110, where it is expanded to produce an expanded gas 114 or turbine exhaust gas. As a result, the turbine 110 generates power, which can be used to power both an electric generator 112 to produce electricity and a pump 152 by a common shaft 160. In other words, the turbine 110 can produce mechanical power, electrical power, or both.

The expanded gas 114 enters a recuperative heat exchanger 116 where recycled sCO₂ 156 is preheated and introduced to the combustor 106 as preheated recycled sCO₂ 158. The expanded gas 114 is cooled in the recuperative heat exchanger 116 and the cooled exhaust gas 118 from the recuperative heat exchanger 116 enters a water and condensables condenser 120 in which water and other condensibles in the cooled exhaust gas 118 are condensed and passed to a separator 128. The separator 128 removes most of the water and condensables as a stream 130 at temperatures above the liquefaction temperature of CO₂. The gas 132 from the separator 128 enters a CO₂ condenser 134, where CO₂ is liquefied.

A heat rejection system 126 is used to provide a cooling media for use in the water and condensables condenser 120 and from the CO₂ condenser 134. The heat rejection system 126 may be dry air, wet evaporative, chiller-based, waste cold energy source based, river once-thru, ocean water once-thru, or any combination thereof. The cooling media is recirculated to the water and condensables condenser 120 using cooling medium supply pipe 124 and return pipe 122 and transports heat from the water and condensables condenser 120 to the heat rejection system 126. Similarly, the cooling media is recirculated to the CO₂ condenser 134 using cooling medium supply pipe 136 and return pipe 138 and transports heat from the CO₂ condenser 134 to the heat rejection system 126.

The liquefied CO₂ and remaining exhaust gases 140 from the CO₂ condenser 134 are passed to a CO₂ separator 142. The CO₂ separator 142 separates the liquid CO₂ 150 from the exhaust gases 144. The liquid CO₂ 150 is passed to a pump 152 that pressurizes the liquid CO₂ to provide recycled sCO₂ 156 to the recuperative heat exchanger 116 where heat is passed from the expanded gas or turbine exhaust gas 114 to the recycled sCO₂ 156 to provide the preheated sCO₂ 158 for the combustor 106. It should be appreciated that the pump 152 uses an extraction stream 154 to remove excess CO₂ from the sCO₂ and, therefore, from the recycled sCO₂ and from the thermodynamic cycle. The extraction stream 154 can provide saleable sCO₂ and is intended to provide the sCO₂ pressure and purity desired. It should be appreciated that no compressors are necessary in the process 100.

The exhaust gases 140 from the CO₂ separator 142 are expanded in an expander 146, and exhaust gases 148 from the expander 146 are discharged to the atmosphere. The expander 146 generates power to power the common shaft 160. It should be appreciated that the common shaft 160 is common to the turbine 110, the electric generator 112, and the pump 152. Therefore, it should be appreciated that the operating speeds of turbine 110, electric generator 112, expander 146, and pump 152 may be different in order to maximize their respective efficiencies. Thus, common shaft 160 may also include speed-changing gears.

In some embodiments, the following conditions may be used:

| Point | | | Min. Temp. | Max. Temp. | Min. Press. | Max Press. |
|---|---|---|---|---|---|---|
| Number | Equipment | Medium | deg C. | deg C. | bar-abs. | bar-abs. |
| 100 | | | | | | |
| 102 | | Oxygen | 0 | 200 | 315 | 800 |
| 104 | | Fuel | 0 | 200 | 315 | 800 |
| 106 | Combustor | Post Combustion Gases | | | | |
| 108 | | Post Combustion Gases | 1000 | 1650 | 300 | 750 |
| 110 | Turbine | | | | | |
| 112 | El. Generator | | | | | |
| 114 | | Post Combustion Gases | 300 | 950 | 55 | 80 |
| 116 | Recuperative Heat Exchanger | | | | | |
| 118 | | Post Combustion Gases | 35 | 150 | 55 | 80 |
| 120 | Water Condenser | | | | | |
| 122 | | Cooling Medium Supply | 2 | 30 | 2 | 80 |
| 124 | | Cooling Medium Return | 5 | 35 | 2 | 80 |
| 126 | Heat Rejection System | | | | | |
| 128 | Water Separator | | | | | |
| 130 | | Water and Condensibles' Removal | 3 | 30 | 55 | 80 |
| 132 | | | | | | |
| 134 | CO2 Condenser | | | | | |
| 136 | | Cooling Medium Supply | 2 | 30 | 2 | 80 |
| 138 | | Cooling Medium Return | 5 | 35 | 2 | 80 |
| 140 | | Liquid CO2 and Exhaust Gases | 3 | 32 | 55 | 80 |
| 142 | Liquid CO2 Separator | | | | | |
| 144 | | Exhaust Gases | 3 | 32 | 55 | 80 |
| 146 | Exhaust Gas Expander | | | | | |
| 148 | | Exhaust Gases | −160 | 25 | 1.025 | 1.5 |
| 150 | | Liquid CO2 | 3 | 32 | 55 | 80 |
| 152 | CO2 Pump with Extraction | | | | | |
| 154 | | Extracted Excess of sCO2 for Export | 12 | 50 | 75 | 170 |
| 156 | | Recycled sCO2 | 15 | 55 | 315 | 800 |
| 158 | | Recycled sCO2 | 300 | 850 | 315 | 800 |
| 160 | Common Shaft Drive | | | | | |

What is claimed is:

1. A method for utilizing supercritical carbon dioxide in an open thermodynamic cycle, comprising:
combusting oxygen, fuel, and preheated recycled supercritical carbon dioxide to produce a combusted gas;
expanding the combusted gas to produce power and an expanded gas;
heating recycled supercritical carbon dioxide with the expanded gas to produce the preheated recycled supercritical carbon dioxide and an exhaust gas comprising carbon dioxide;
condensing the exhaust gas to remove at least a portion of water from the exhaust gas;
liquefying carbon dioxide from the exhaust gas to produce a liquefied carbon dioxide;
pressurizing the liquefied carbon dioxide to produce the recycled super critical carbon dioxide; and
removing a portion of excess supercritical carbon dioxide from the recycled super critical carbon dioxide.

2. The method of claim 1, wherein said expanding comprises expanding the combusted gas to produce mechanical power.

3. The method of claim 2, wherein said pressurizing is performed using a pump and further comprising:
using the mechanical power to power the pump.

4. The method of claim 1, wherein said expanding comprises expanding the combusted gas to produce electrical power.

5. The method of claim 1, further comprising:
separating remaining exhaust gases from the liquefied carbon dioxide.

6. The method of claim 5, wherein said separating remaining exhaust gases produces a separated exhaust gas and further comprising:
expanding the separated exhaust gas to produce power.

7. The method of claim 6, wherein said pressurizing is performed using a pump and further comprising:
using the power produced by said expanding the separated exhaust gas to power the pump.

8. The method of claim 7, wherein said expanding comprises expanding the combusted gas to produce power and further comprising:
using the power produced by said expanding the combusted gas to power the pump.

9. The method of claim 8, wherein said using the power produced by said expanding the separated exhaust gas to power the pump and said using the power produced by said expanding the combusted gas to power the pump are performed using the same shaft.

10. The method of claim 1, wherein the recycled super critical carbon dioxide is produced without a compressor.
